(19) United States
(12) Patent Application Publication
(10) Pub. No.: US 2016/0335711 A1
(43) Pub. Date: Nov. 17, 2016

(54) Personal styler

(71) Applicants: Nicole McKay Hickman, Palo Alto, CA (US); Waukeshia Denise Jackson, Chula Vista, CA (US)

(72) Inventors: Nicole McKay Hickman, Palo Alto, CA (US); Waukeshia Denise Jackson, Chula Vista, CA (US)

(73) Assignee: Egami Media Group, Palo Alto, CA (US)

(21) Appl. No.: 14/545,509

(22) Filed: May 13, 2015

(51) Int. Cl. G06Q 30/06; G06K 9/46; G06K 9/62; G06T 7/40; A45D 44/00; G06K 9/00

(52) U.S. Cl. CPC G06Q 30/0643; A45D 44/005; G06K 9/00362; G06K 9/6267; G06T 7/408; G06K 9/4652; G06Q 30/0631; G06T 2207/30196; G06T 2207/30124

(57) ABSTRACT

Disclosed are various embodiments for implementing a personal styler application that may identify garments, accessories, hair styles, cosmetics, and/or other items based on a set of attributes associated with image of an individual that has been received in a computing device. The personal styler application obtains an image of a person over a network from a client. The personal styler application determines a body shape of the person from a plurality of predetermined body shapes based at least in part on the image of the person. The personal styler application identifies one or more items that best compliment the body shape associated with the image of the person.

### BACKGROUND

It is difficult for the average consumer to select fashionable and flattering clothing items for their individual body types. People, sometimes gain or lose weight which often results in changes in the individual's body size or shape. Therefore, there is a need to minimize spending on clothing items that do not accentuate an individual's body type in order to eliminate items in an individual's closet that do not fit optimally on an individual due to size and shape.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 shows a drawing of a networked environment according to various embodiments of the present disclosure.

FIG. 2 is a drawing of a user interface rendered on a client in the networked environment of FIG. 1 according to various embodiments of the present disclosure.

FIG. 3 presents a drawing of another example of a user interface rendered on a client in the networked environment of FIG. 1 according to various embodiments of the present disclosure.

FIG. 4 is a flowchart illustrating one example of the functionality of the styler application in determining the body shape of a person depicted in an image obtained from a server in the networked environment of FIG. 1 according to various embodiments of the present disclosure.

FIG. 5 is a flowchart illustrating one example of the functionality of the styler application that is implemented to facilitate the generation of a user profile corresponding to a person depicted in an image obtained from a server in the networked environment of FIG. 1 according to various embodiments of the present disclosure.

FIG. 6 is a flowchart illustrating one example of the functionality of the styler application that is implemented to facilitate the purchase of one or more items in response to a query according to various embodiments of the present disclosure.

FIG. 7 is a drawing of one example of a server in the networked environment of FIG. 1 according to various embodiments of the present disclosure.

### DETAILED DESCRIPTION

The present disclosure relates to implementing a personal styler application that may identify garments, accessories, hair styles, cosmetics, and/or other items based on an image of an individual that has been received in a computing device. Various embodiments of the present disclosure facilitate the determination of an individual's body shape and the selection of garments, accessories, and other items suitable for the individual's body shape based on the image received by the computing device. For example, in some embodiments, the personal styler application may be executed by a computing device such as a server. The personal styler application receives one or more images of an individual from a client over a network. The personal styler application determines attributes associated with the individual in the one or more images, such as, for example, a body shape, an eye color, a hair color, a skin tone, a face shape, and/or other attributes associated with the individual. The personal styler application also generates a user profile based on the image that is ultimately rendered in the form of a user interface on a client device. Additionally, the personal styler application may identify one or more items such as, for example, garments, accessories, hair styles, cosmetic items, shoes, and/or other items that may be suitable for the body shape, hair color, face shape, skin tone, and/or other attributes of the individual depicted in the image. The personal styler application may also display a model of a user selected one of the garments on a simulation of the body shape. The personal styler application may also facilitate the purchase of one or more of the identified items in response to a user input received from a client device over a network. In the following discussion, a general description of the system and its components is provided, followed by a discussion of the operation of the same.

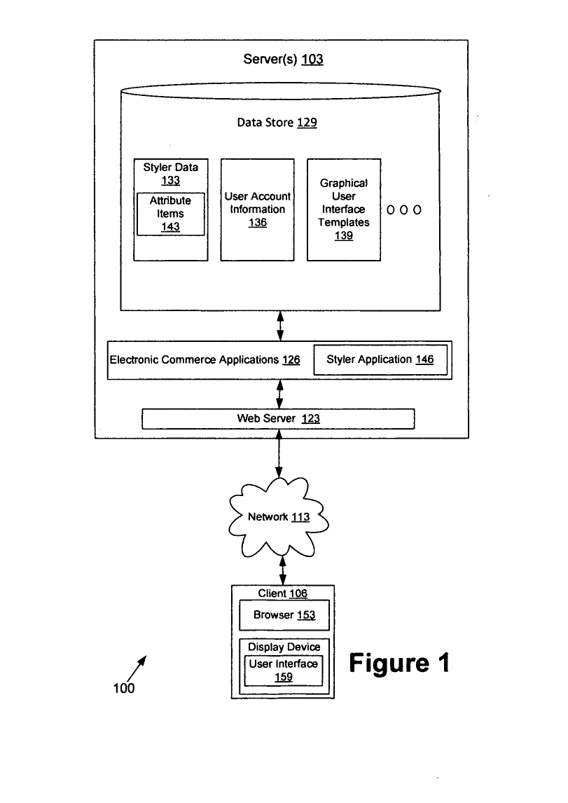

With reference to FIG. 1, shown is a networked environment 100 that includes, for example, at least one server 103, and a client 106. The server 103 may represent multiple servers that may be arranged to work in coordination with each other. Alternatively, such servers 103 may be arranged in some other manner, as can be appreciated. The client 106 is configured to access information on the server 103 as will be described. Both the server 103 and the client 106 are coupled to a network 113. The client 106 may comprise for example, a processor-based system such as a computer system. Such a computer system may be embodied in the form of a desktop computer, a laptop computer, a personal digital assistant, a cellular telephone, web pads, tablet computer systems, smartphones, and other devices with like capability. The network 113 may comprise, for example, any type of network environment such as the Internet, intranets, local area networks, wide area networks, wireless networks, or other networks, or a combination of two or more of such networks as can be appreciated. Although only a single client 106 is shown, the client 106 represents many clients 106 that can exist on the network 113.

According to various embodiments, the server 103 includes various applications that are executed, for example, to effect the identification and purchase of items suitable for a specific body type based on an image received by the server 103 from the client 106 over a network 113. To this end, the systems executed on the servers 103 include, for example, a web server 123, and various electronic commerce applications 126. The web server 123 comprises a subsystem that is employed to provide browser access to the various electronic commerce applications 126, although it is understood that other technologies beyond web servers 123 may be employed.

The electronic commerce applications 126 are executed in order to receive orders for goods and/or services such as, for example, clothing, shoes, accessories, cosmetics, and/or other items selected by the client 106. The electronic commerce applications 126 also ensure the fulfillment of such orders as is consistent with the operations of online merchants, for example, that employ such online systems. To this end, the electronic commerce applications 126 may access data stored in a data store 129. The data in the data store 129 is used during the normal operation of the electronic commerce applications 126. For example, stored within the data store 129 are styler data 133, user account information 136, graphical user interface templates 139, and other information as can be appreciated.

The styler data 133 may include various information about the goods and/or services that may be offered for sale in the electronics commerce applications 126. The goods and/or services may comprise, for example, clothing, accessories, shoes, hair style services, cosmetics, and other goods and/or services as can be appreciated. The user account information 136 may include personal information about various customers such as, for example, account number, name, address, passwords, methods of payment such as credit card numbers, personal interests, and other information used by a merchant to market goods to such users. The templates 139 may include various user interface layouts and other components that are used by the electronic commerce applications 126 to generate user interfaces that are served up to the client 106 as will be described. In addition, there may be other information included in the data store 129 in order to conduct electronic commerce as can be appreciated.

Also, stored in the data store 129 are attribute items 143 that be listed within the styler data 133. Such attribute items 143 may include for example, a predetermined lists of body shapes, a predetermined list of skin tones, a predetermined list of face types, a predetermined list of hair colors, a predetermined list of eye colors, a predetermined list of hair styles, a predetermined list of color palettes, and other information as can be appreciated.

The electronic commerce applications 126 may comprise a slyer application 146. According to various embodiments, the styler application 146 is executed by the server 103 as part of the electronic commerce applications 126 to facilitate the determination of a body shape of associated with a person depicted in an image received by the server 103 from a client 106 over a network 113. Additionally, the styler application 146 may be executed in the server 103 as part of the electronic commerce applications 126 to identify one or more goods and/or services based on the body shape associated with the person in the image that has been received by the server 103 from the client 106 over the network 113. The styler application 146 may also be executed in the server 103 as part of the electronic commerce applications 126 to facilitate the ordering of one or more of the goods and/or services over the network 113 using the client 106. While the styler application 146 is shown as a part of the electronic commerce applications 126, it is possible that the styler application 143 may employ some other technology that allows the styler application 146 to interface with the server 103 as can be appreciated.

The client 106 may include a browser 153 that is manipulated to interface with the web server 123 to allow the client 106 to interface with the electronic commerce applications 126 as can be appreciated. In addition, the client 106 may include a display device 156 that is employed to render user interfaces 159 that may comprise a portion of a network page such as a web page, for example, that is encoded by the electronic commerce applications 126 and served up to the client 106 through the web server 123. Such network pages may be generated dynamically using various software platforms such as AJAX, PERL, JAVA, or other software platforms as can be appreciated. While the client 106 is shown as including a browser 153, it is possible that the client 106 may employ some other technology that allows the client 106 to interface with the server 103 as can be appreciated.

The user of a client 106 may manipulate the respective user interfaces 159 to affect the purchase of one or more of the identified goods and/or services. In addition, a user may manipulate the user interface(s) 159 rendered on the display device 156 of the client 106 to facilitate other functions as will be described. The display device 156 may be any type of display device including a liquid crystal display (LCD), a cathode-ray tube (CRT), a flat plasma panel display, or other display device.

Next, a general description of the operation of the various components of the networked environment 100 is provided. To begin, a user at a client 106 sends a request to a server 103 to launch a styler application 146. The server 103 executes the styler application 146 in response to the appropriate user input. On first access, the styler application 146 may query the client 106 for user account information 136. Additionally, the styler application 146 may facilitate the creation of the user account information 136 by providing one or more user interfaces 159 for the establishing the user account information 136 if the user account information 136 has not already been established. For instance, the styler application 146 may prompt the user to indicate a name for the user account information 136, a password for the user account information 136, and/or other parameters or other information for establishing the user account information 136. The user account information 136 may also be accessed by the electronic commerce applications 126.

In one embodiment, a user employing a client 106 sends an image of a person to the server 103 over a network 113. The styler application 146 may determine a body shape associated with the person depicted in the image. In one embodiment, the styler application 146 may be configured to perform a two-dimensional scan of the person depicted in the image such that the body shape is determined based at least in part on the two-dimensional scan. In other embodiment, the styler application 146 may be configured to send a request to a client 106 for at least one body measurement associated with the person depicted in the image such as, for example, a shoe size, a clothing size, a bust size, a hip size, a waist size, height, weight, and other body measurements. The styler application 146, obtains, in response to a user input, at least one body measurement associated with the person depicted in the image and determines the body shape associated with the person based on the body measurement. For example, the styler application 146 may determine that the body shape associated with the person depicted in the image is a straight body shape in which the styler application 146 may be configured to determine that the bust and the hips associated with the person depicted in the image are approximately the same size and the waist associated with the person depicted in the image is slight smaller than both the bust and the hips. In another example, the styler application 146 may determine the body shape associated with person depicted in image is a pear body shape in which the styler application 146 is configured to determine that the hips associated with the person depicted in the image are larger than the bust associated with the person depicted in the image and the waist associated with the person depicted in the image gradually slopes out to the hips. In another example, the styler application 146 may determine that the body shape associated with the person depicted in the image is a spoon body shape in which the slyer application 146 is configured to determine that the hips associated with the person depicted in the image are larger than the bust associated with the person depicted in the image and the waist associated with the person depicted in the image is slightly smaller than the bust. In yet another example, the styler application 146 may determine that the body shape associated with the person depicted in the image is an hourglass shape in which the styler application 146 is configured to determine that the bust associated with the person depicted in the image and the hips associated with the person depicted in the image are approximately the same size and the waist associated with the person depicted in the image is well-defined. In another example, the styler application 146 may determine that the body shape associated with the person depicted In the image is a top hourglass shape in which the styler application 146 is configured to determine that the bust associated with the person depicted in the image is larger than the hips associated with the person depicted in the image and the waist associated with the person depicted in the image is well-defined. In still yet another example, the styler application 146 may determine that the body shape associated with the person depicted in the image is an inverted triangle body shape in which the styler application 146 is configured to determine that the bust associated with the person depicted In the image is large, the hips associated with the person depicted in the image are narrow, and the waist associated with the person depicted in the image is not well-defined. In yet another example, the styler application 146 may determine that the body shape associated with the person depicted in the image is an oval body shape in which the styler application 146 is configured to determine that the waist associated with the person depicted in the image is larger than the bust and hips associated with the person depicted in the image and the hips are narrow in comparison with the shoulders associated with the person depicted in image. In still yet another example, the styler application 146 may determine that the body shape associated with person depicted in the image is a diamond body shape in which the styler application 146 is configured to determine that the waist associated with the person depicted in the image is larger than the bust associated with the person depicted In the image, and the shoulders are narrow compared to the hips, and the breasts associated with the person depicted in the image are small to medium in size.

The styler application 146 may also be configured to determine other body shapes and attributes associated with the person depicted in the image. For example, the styler application 146 may be configured to determine a skin tone associated with the person depicted in the image. For example, the skin tone may be the warm, cool or neutral hue that shows through the surface of the skin. Warm skin tones may appear yellow, gold, peach, olive, or combinations thereof. Cool skin tones may appear pink, blue, red, and combinations thereof. Neutral skin tones lack the yellow, gold, peach, and olive hue associated with warm skin tones and neutral skin tones lack the pink, red, and blue hue associated with cool skin tones.

Once the styler application 146 determines the skin tone associated with the person depicted in the image, the styler application 146 may determine a color palette comprising a plurality of colors based on the skin tone. For example, the styler application 146 may be configured to perform a color analysis to determine which palette of colors best compliments the skin tone associated with the person depicted in the image. The color analysis may also be based on the hair color associated with the person depicted in the image, the eye color associated with the person depicted in the image, the lip color associated with the person depicted in the image, and combinations thereof. The styler application 146 may identify one or more garments to present to the user via a user interface 159 based on the body shape, the color palette, and combinations thereof. The styler application 146 may be configured to store the identified one or more garments to the data store 129. Similarly, the styler application 146 may also be configured to identify at least one cosmetic item corresponding to the color palette. Also, the styler application 146 may be configured to identify one or more accessories that compliment the identified one or more garments. Additionally, the styler application 146 may be configured to allow a user to select one or more garments from the identified garments for purchase using the electronic commerce application 126. The styler application 146 may store the user selected one or more garments to the data store 129. In one embodiment, a user employing a client 106 may provide a garment type to the server 103 over a network 113 that is obtained by the styler application 146. The styler application 146 may identify the one or more garments based on the garment type. Garment types may include for example, formal, business casual, sportswear, business, party, and other garment types. In another embodiment, the styler application 146 may obtain style preference associated with the at least one garment type, wherein the at least one garment is identified based at least in part on the style preference. For example, the style preference may be conservative, contemporary, couture, modern, traditional, other style preferences. In yet another embodiment, the styler application 146 obtains, in response to a user input, an occasion type associated with the at least one garment type, wherein the at least one garment is identified based at least in part on the occasion type. For example, occasion types may be prom, wedding, birthday, vacation, and/or other occasion types.

In still yet another environment, the styler application 146 may be configured to determine a set of attributes associated with the person depicted in the image. For example, the set of attributes may include a face shape, an eye color, a hair color, a lip color, and other attributes associated with the person depicted in the image. The styler application 146 may be configured to identify one or more items that compliment the person depicted in the image based at least in part on the set of attributes. Additionally, the styler application 146 may be configured to store the set of attributes associated with the person depicted in the image and generate a user profile for rendering on a user interface 159, wherein the user profile is based at least in part on the set of attributes. For example, the user profile may include a body shape, a skin tone, an eye color, a hair color, a face shape, a color palette, the identified at least one items that compliment the person depicted in the image, the user selected one or more items, and combinations thereof.

In other embodiment, the styler application 146 may be configured to send a request to the client 106 for one or more images of at least one clothing item. A user employing the client 106 may send one or more images of clothing items to the server 103 over a network 113. The styler application 146 obtains the one or more images of the clothing items and stores the one or more images of the clothing items to the data store 129, The styler application 146 may be configured to identify at least one item from the Internet, the images stored in the data store 129, and combinations thereof, that compliment the person depicted in the image based at least in part on the one or more images of the at least one clothing item. In one embodiment, the styler application 146 may be configured to encode in the server 103 a network page that facilitates a specification of one or more filter rules. For example, the filter rules may permit a user to indicate a price range, a style preference, an occasion type, a vendor, an item type, and/or other filter rules. The styler application 146 may be configured to identify the at least one item based at least in part on the specified one or more filter rules. The styler application 146 may perform, a query of the Internet, the stored one or more images of the at least one clothing item, and combinations thereof, wherein the query is based at least in part on the specified one or more filter rules. The styler application 146 may also be configured to generate a set of results in response to the query, wherein the set of results comprises one or more images obtained from the Internet, one or more images of items that compliment the body shape, skin tone, face shape, hair color, lip color, and other attributes of the person depicted in the image. In one embodiment, the styler application 146 may obtain the one or more images of items from the Internet, the stored one or more images of the at least one clothing item, and combinations thereof. The styler application 146 may also be configured to encode the set of results for rendering for display on a user interface 159.

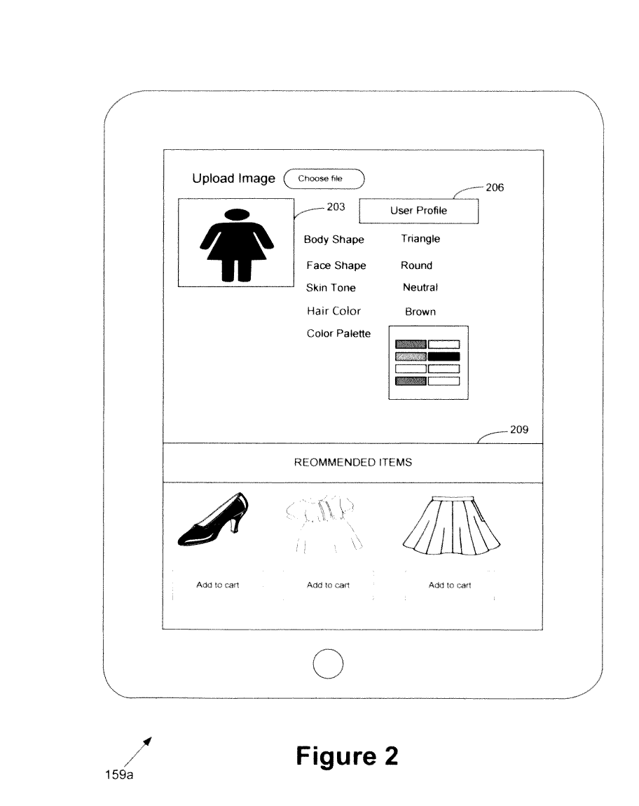

Referring next to FIG. 2, shown is one example of a client 106 upon which is rendered a user interface 159, denoted herein as user interface 159a, according to various embodiments. The user interface 159a is rendered on a display device 153 of the client 106 in the networked environment 100 (FIG. 1). Specifically, FIG. 2 depicts one example of a user interface 159a in which an image 203 of a person is provided by a user employing a client 106 to a server 103 (FIG. 1) over a network 113 (FIG. 1). The user interface 159a also shows an example of a profile 206 generated by the styler application 146 (FIG. 1) in which the profile includes attributes associated with the image 203 that have been determined by the styler application 146 (FIG. 1) such as, for example, a body shape, a face shape, a hair color, an eye color, a lip color, a color palette, and other attributes associated with the person depicted in the image 203. The user interface 159a also shows one or more recommended items 209 that best compliment the person depicted in the image 203. The recommended items 209 may be identified by the styler application 146 (FIG. 1) and may include garments, accessories, cosmetic items, shoes, and other recommended items. FIG. 2 is merely an example of a user interface 159a, it is understood that other types of user interfaces 159a may be employed in the embodiments of the present disclosure. The layout of the various elements in the user interface 159a as shown in FIG. 2 is provided merely as an example, and is not intended to be limiting. Other types of user interfaces 159a may be employed such as, for example, games, simulations, document viewers, movies, videos, and/or other types of user interfaces 159a. Additionally, the graphical components comprising information shown in FIG. 2 are merely examples of various types of features that may be used to accomplish the specific function noted. Because the client 106 is decoupled from the hardware requirements of the styler application 146, the styler application 146 may be used by a variety of clients 106.

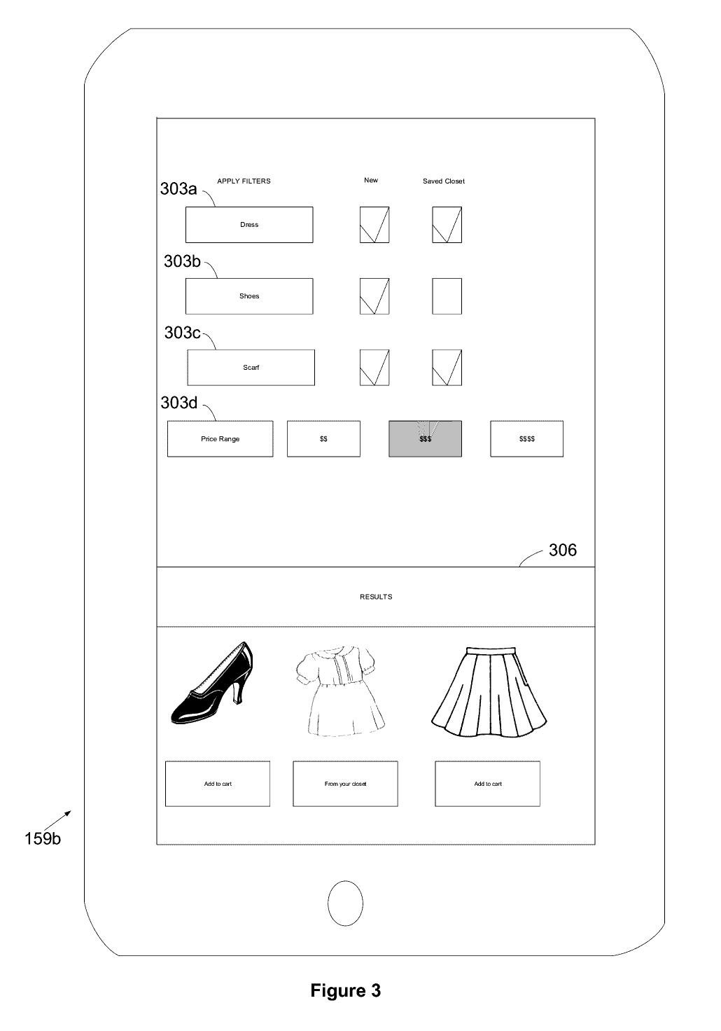

Referring now to FIG. 3, shown is a user interface 159 generated on the display device 156 of the client 106, denoted herein as user interface 159b, according to various embodiments. The user interface 159b is similar to the user interface 159a with the exception that the user interface 159b includes a set of filter rules 303. The set of filter rules 303 includes a specification that allows a user to select one or more of the set of filter rules 303. The styler application 146 (FIG. 1) may perform a query of the Internet, of the one or more images of clothing items stored in the data store 129 (FIG. 1), and combinations thereof, the query being based on the one or more of the filter rules. The styler application 146 (FIG. 1) may generate a set of results comprising one or more garments in response to the query and encode the set of results for rendering on a display device 156 in the form of a user interface 159b on a client 106.

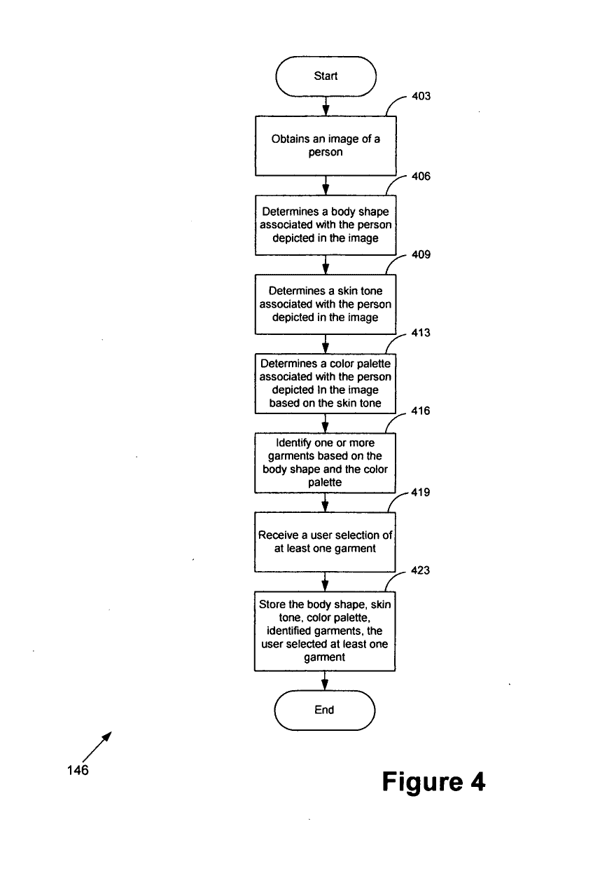

Turning now to FIG. 4, shown is a flowchart that provides one example of the operation of a portion of the styler application 146 according to various embodiments. It is understood that the flowchart of FIG. 4 provides merely an example of the many different types of functional components that may be employed to implement the operation of the styler application 146 as described herein. As an alternative, the flowchart of FIG. 4 may be viewed as depicting an example of steps of a method implemented in the server 103 (FIG. 1) according to various embodiments. The flowchart sets forth an example of the functionality of the styler application 146 in determining the body shape of a person depicted in an image 203 (FIG. 2) according to various embodiments. While determining a body shape is discussed, it is understood that this is merely an example of the many different types of attributes that may be determined with the uses of the styler application 146. In addition, the flowchart of FIG. 4 provides an example of how the styler application 146 identifies garments, hair styles, accessories, cosmetics, and other items based on the attributes of the person depicted in the image 203 (FIG. 2). It is understood that the flow may differ depending on the specific circumstances. Also, it is understood that other flows and user actions may be employed other than those described herein.

Beginning in box 403, when a user employing a client 106 (FIG. 1) sends an image 203 (FIG. 2) of a person to a sever 103 (FIG. 1) over a network 113 (FIG. 1), the styler application 146 obtains the image 203 (FIG. 2). In box 406, the styler application 146 determines a body shape associated with the person depicted in the image 203 (FIG. 2) from a predetermined list of a plurality body shapes. The styler application 146 moves to box 409 and performs a color analysis to determine a skin tone associated with the person depicted in the image 203 from a predetermined list of a plurality of skin tones. Subsequently, the styler application 146 moves to box 413 and determines a color palette comprising a plurality of colors that best compliment the skin tone of the person depicted in the image 203 (FIG. 2) based on the skin tone of the person depicted in the image 203 (FIG. 2). The styler application then moves to box 416 and identifies one or more garments that best compliment the body shape and skin tone of the person depicted in the image 203 (FIG. 2) based on the body shape and color palette. Additionally, the styler application 146 may identify one or more cosmetic items, accessories, shoes, and other items based on the body shape and color palette associated with the person depicted in the image 203 (FIG. 1). The styler application 146 then moves to box 419 and receives a user input corresponding to a selection of at least one of the identified garments, cosmetic items, accessories, shoes or other items. In one embodiment, the user selected item may be accessed by the electronic commerce applications 126 in order to facilitate the purchase of the user selected item. Next, the styler application 146 moves to box 423 and stores the body shape, the skin tone, the one or more identified garments, and the user selected item to the data store 129 (FIG. 1).

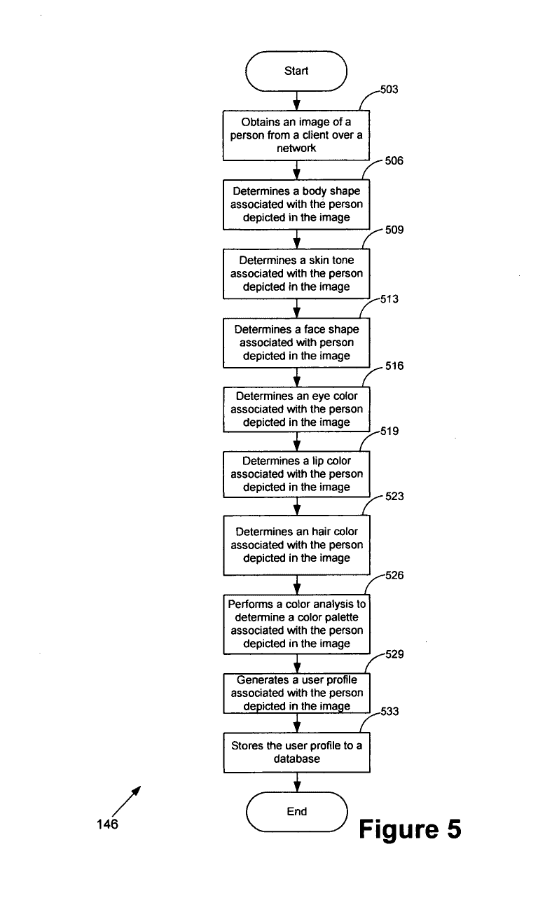

Referring now to FIG. 5, shown is a flowchart that provides one example of the operation of a portion of the styler application 146 that is implemented to facilitate the generation of a user profile corresponding to a person depicted in an image 203 (FIG. 1) according to various embodiments. It is understood that the flowchart of FIG. 5 provides merely an example of the many different types of functional components that may be employed to implement the operation of the portion of the styler application 146 as described herein. As an alternative, the flowchart of FIG. 5 may be viewed as depicting an example steps of a method implemented in the networked environment 100 (FIG. 1) according to one or more embodiments.

Beginning in box 503, the styler application 146 obtains an image 203 (FIG. 2) of a person from a server 103 (FIG. 1) sent by a user employing a client 106 (FIG. 1) over a network 113 (FIG. 1). The styler application 146 moves to box 506 to determine a body shape associated with the person depicted in the image 203 (FIG. 2) from a predetermined list of a plurality body of shapes. The styler application 146 then moves to box 509 to determine a skin tone associated with the person depicted in the image 203 (FIG. 2) from a predetermined list of a plurality of skin tones. The styler application 146 moves to box 513 to determine a face shape associated with the person depicted in the image 203 (FIG. 2) from a predetermined list of a plurality of face shapes. Next, the styler application 146 moves to box 516 and determines an eye color associated with the person depicted in the image 203 (FIG. 2) from a predetermined list of a plurality of eye colors. The styler application 146 then moves to box 519 and determines a lip color associated with the person depicted in the image 203 (FIG. 2) from a predetermined list of a plurality of lip colors. The styler application 146 then moves to box 523 to determine a hair color associated with the person depicted in the image 203 (FIG. 2) from a predetermined list of a plurality of hair colors. Next, the styler application 146 moves to box 526 and performs a color analysis to determine a color palette associated with the person depicted in the image 203 (FIG. 2). In one embodiment, the color palette is based on the skin tone associated with the person depicted in the image 203 (FIG. 2). In another embodiment, the color palette is based on the lip color associated with the person depicted in the image 203 (FIG. 2). In yet another embodiment, the color palette is based on the hair color associated with the person depicted in the image 203 (FIG. 2). In still yet another embodiment, the color palette is based on the eye color associated with the person depicted in the image 203 (FIG. 2). The color palette may comprise a plurality of colors that best compliment the skin tone, the eye color, the lip, the hair, and combinations thereof associated with the person depicted in the image 203 (FIG. 2). The styler application 146 may then move to box 529 and generates a user profile comprising the body shape, the face shape, the eye color, the lip color, the hair color, the color palette, and combinations thereof associated with the person depicted in the image 203 (FIG. 2). The styler application 146 then moves to box 533 stores the user profile to the data store 129 (FIG. 1).

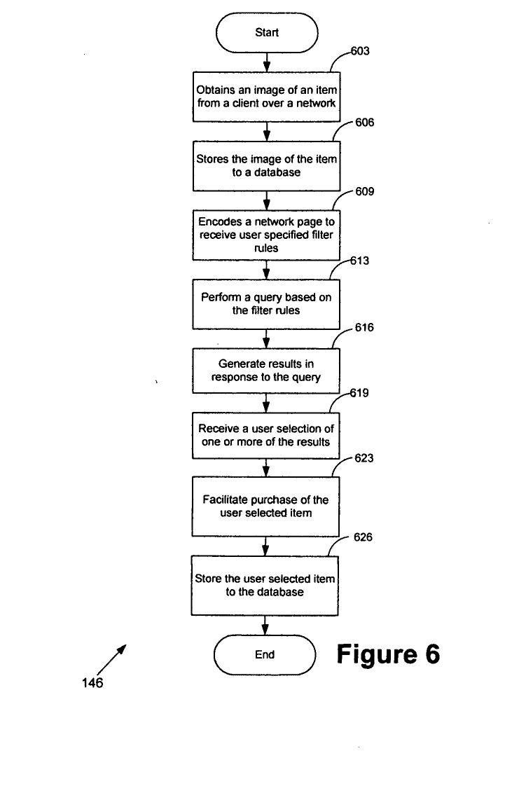

Referring now to FIG. 6, shown is a flowchart that provides one example of the operation of a portion of the styler application 146 that is implemented to facilitate the purchase of one or more items in response to a query according to various embodiments. It is understood that the flowchart of FIG. 6 provides merely an example of the many different types of functional components that may be employed to implement the operation of the portion of the styler application 146 as described herein. As an alternative, the flowchart of FIG. 6 may be viewed as depicting an example of steps of a method implemented in the networked environment 100 (FIG. 1) according to one or more embodiments.

Beginning in box 603, the styler application 146 obtains an image of an item from the server 103 (FIG. 1) sent by a client 106 (FIG. 1) over a network 113 (FIG. 1). For example, the image may depict items such as, a clothing item, an accessory item, shoes, and/or other items. The styler application 146 then moves to box 606 and stores the image of the item to the data store 129 (FIG. 1). The styler application 146 then moves to box 609 and encodes a network page that facilitates a specification of one or more filter rules. The styler application 146 then moves to box 613 and receives a user specification of the one or more of the filter rules. Upon receipt of the user specified one or more of the filter rules, the styler application 146 moves to box 616 and performs a query of the Internet, the images of items stored in the data store 129 (FIG. 1), and combinations thereof, such that the query is based at least in part on the user specified one or more filter rules. The styler application 146 then moves to box 619 and generates a set of results in response to the query, such that the set of results comprises one or more images from the Internet, one or more images from the data store 129 (FIG. 1), and combinations thereof. The styler application 146 moves to box 623 and receives a user selection corresponding to one or more images of items from the Internet. The styler application 146 then moves to box 626 to facilitate a purchase of the user selected one or more items via the electronic commerce applications 126 (FIG. 1). The styler application 146 then moves to box 629 and stores an image of the purchased item to the data store 129 (FIG. 1).

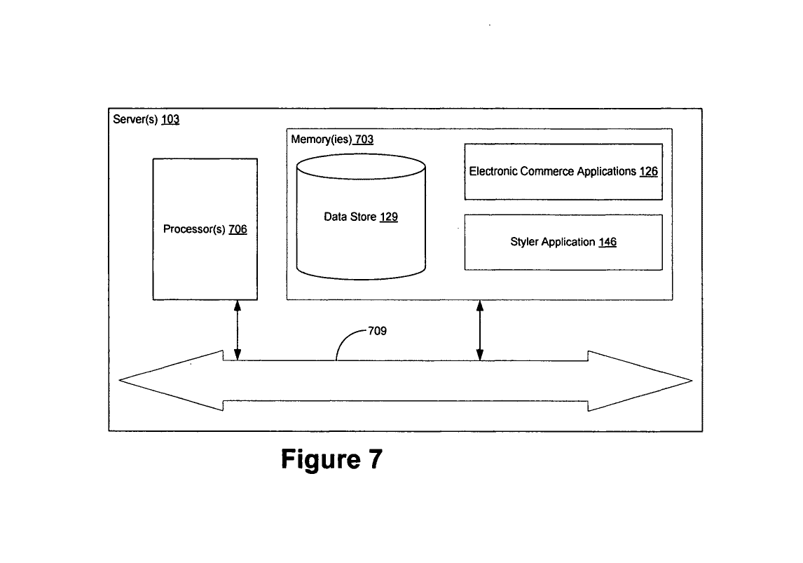

With reference to FIG. 7 shown is a schematic block diagram of the server(s) 103 according to an embodiment of the present disclosure. The server(s) 103 includes at least one processor circuit, for example, having a processor 706 and a memory 703, both of which are coupled to a local interface 709. To this end, the server(s) 103 may comprise, for example, at least one server computer or like device. The local interface 709 may comprise, for example, a data bus with an accompanying address control bus or other bus structure as can be appreciated. Stored in the memory 703 are both data and several components that are executable by the processor 706. In particular, stored in the memory 703 and executable by the processor 706 are the electronic commerce applications 126, the styler application 146 and potentially other applications. Also stored in the memory 703 may be a data store 129 and other data. In addition, an operating system may be stored in the memory 703 and executable by the processor 706.

It is understood that there may be other applications that are stored in the memory 703 and are executable by the processors 706 as can be appreciated. Where any component discussed herein is implemented in the form of software, anyone of a number of programming languages may be employed such as, for example, C, C++, C#, Objective C, Java, Javascript, Perl, PHP, Visual Basic, Python, Ruby, Delphi, Flash, or other programming languages.

A number of software components are stored in the memory 703 and are executable by the processor 706. In this respect, the term “executable” means a program file that is in a form that can ultimately be run by the processor 706. Examples of executable programs may be, for example, a compiled program that can be translated into machine code in a format that can be loaded into a random access portion of the memory 703 and run by the processor 706, source code that may be expressed in proper format such as object code that is capable of being loaded into a random access portion of the memory 703 and executed by the processor 706, or source code that may be interpreted by another executable program to generate instructions in a random access portion of the memory 703 to be executed by the processor 706, etc. An executable program may be stored in any portion or component of the memory 703 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 703 is defined herein as including both volatile and nonvolatile memory and data storage components. Volatile components are those that do not retain data values upon loss of power. Nonvolatile components are those that retain data upon a loss of power. Thus, the memory 703 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 706 may represent multiple processors 406 and the memory 703 may represent multiple memories 703 that operate in parallel processing circuits, respectively. In such a case, the local interface 709 may be an appropriate network 113 (FIG. 1) that facilitates communication between any two of the multiple processors 706, between any processor 706 and any of the memories 703, or between any two of the memories 703, etc. The local interface 709 may comprise additional systems designed to coordinate this communication, including, for example, performing load balancing. The processor 706 may be of electrical or of some other available construction.

Although the electronic commerce applications 126, the styler application 146, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or steady state machine that employs any one of or—a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowcharts of FIG. 4, FIG. 5 and FIG. 6 show the functionality and operation of an implementation of portions of the styler application 146. If embodied in software, each block may represent a module, segment, or portion of code that comprises program instructions to implement the specified logical function(s). The program instructions may be embodied in the form of source code that comprises human-readable statements Written in a programming language or machine code that comprises numerical instructions recognizable by a suitable execution system such as a processor 706 in a computer system or other system. The machine code may be converted from the source code, etc. If embodied in hardware, each block may represent a circuit or a number of interconnected circuits to implement the specified logical function(s).

Although the flowcharts of FIG. 4, FIG. 5, and FIG. 6 show a specific order of execution, it is understood that the order of execution may differ from that which is depicted. For example, the order of execution of two or more blocks may be scrambled relative to the order shown. Also, two or more blocks shown in succession in FIG. 4, FIG. 5, and FIG. 6 may be executed concurrently or with partial concurrence. Further, in some embodiments, one or more of the blocks shown in FIG. 4, FIG. 5, and FIG. 6 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the electronic commerce applications 126 and the styler application 146, that comprises software or code can be embodied in any non-transitory computer-readable medium for use by or in connection with an instruction execution system such as, for example, a processor 706 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

What is claimed is:

1. A non-transitory computer readable medium embodying a program executable in a computing device, the program comprising:
a styler application that determines a body shape of a person based at least in part on an image of the person, wherein the image of the person is obtained by the computing device from a client over a network.

2. The non-transitory computer-readable medium of claim 1, further comprising code that determines a skin tone of the person depicted in the image.

3. The non-transitory computer-readable medium of claim 2, further comprising
code that determines a color palette associated with the person depicted in the image, wherein the color palette is based at least in part on the skin tone of the person depicted in the image.

4. The non-transitory computer-readable medium of claim 3, further comprising
code that identifies one or more garments based at least in part on the body shape, the color palette, and combinations thereof.

5. A system, comprising:
at least one computing device; and
a styler application executable in the at least one computing device, the styler application comprising:
logic that obtains an image of a person over a network from a client;
logic that determines a body shape of the person from a plurality of predetermined body shapes based at least in part on the image of the person;
and
logic that identifies at least one recommended garment from a plurality of garments based at least in part on the body shape, wherein the at least one garment is categorized as being within at least one garment type;

6. The system of claim 5, further comprising logic that performs a two-dimensional scan of the person depicted in the image, wherein the body shape is determined based at least in part on the two-dimensional scan.

7. The system of claim 5, further comprising logic that obtains, in response to a user input, at least one body measurement associated with the person, wherein the at least one body measurement is selected from the group consisting of: shoe size, clothing size, bust size, hip size, waist size, height, and weight.

8. The system of claim 7, wherein the body shape is determined based at least in part on the at least one body measurement.

9. The system of claim 5, further comprising logic that obtains, in response to a user input, a style preference associated with the at least one garment type, wherein the at least one garment is identified based at least in part on the style preference.

10. The system of claim 5, further comprising logic that obtains, in response to a user input, an occasion type associated with the at least one garment type, wherein the at least one garment is identified based at least in part on the occasion type.

11. The system of claim 5, further comprising logic that displays a model of the selected one of the at least one garment on a simulation of the body shape.

12. A method, comprising the steps of:
receiving, in a computing, device, an image of a person over a network from a client;
determining, in a computing device, a set of attributes associated with the person depicted in the image, wherein the set of attributes comprises a body shape, a skin tone, a face shape, an eye color, an hair color, a lip color, and a color palette;
identifying, in the computing device, at least one item from a plurality of items based at least in part on the set of attributes associated with the person depicted in the image;
receiving, in the computing device, a user input corresponding to a selected one of the at least one items;
storing, in the computing device, the set of attributes associated with the person depicted in the image; and
storing, in the computing device, the selected one of the at least one items.

13. The method of claim 12, further comprising the step of generating, in the computing device a user profile for rendering on a user interface, wherein the user profile is based at least in part on the set of attributes, wherein the user profile comprises:
the body shape;
the skin tone;
the eye color;
the hair color;
the face shape;
the color palette;
the identified at least one item;
and
combinations thereof.

14. The method of claim 12, further comprising the steps of:
receiving, in the computing device, one or more images of at least one clothing item from a client;
and
storing, in the computing device the one or more images of the at least one clothing item.

15. The method of claim 14, wherein the step of identifying, in the computing device, the at least one item is based at least in part on the one or more images of the at least one clothing item.

16. The method of claim 12, further comprising the step of identifying, in the computing device, at least one cosmetic item corresponding to the color palette.

17. The method of claim 12, further comprising the step of encoding, in the computing device, a network page that facilitates a specification of one or more filter rules.

18. The method of claim 17, wherein the step of identifying, in the computing device, the at least one item is based at least in part on the specified one or more filter rules.

19. The method of claim 18, further comprising the step of performing, in the computing device, a query of the Internet, the stored one or more images of the at least on clothing item, and combinations thereof, wherein the query is based at least in part on the specified one or more filter rules.

20. The method of claim 19, further comprising the steps of:
generating, in the computing device, a set of results in response to the query, wherein the set of results comprises one or more images obtained from the Internet, one or more images obtained from the stored one or more images of the at least one clothing item, and combinations thereof;
and
encoding, in the computing device, the set of results for rendering for display in the form of a user interface on a client.
